(19) United States
(12) Patent Application Publication
(10) Pub. No.: US 2025/0173198 A1
(43) Pub. Date: May 29, 2025

(54) DATA PROCESSING SYSTEM

(71) Applicant: Arm Limited, Cambridge (GB)

(72) Inventors: David Thomas Garbett, Cambridge (GB); Ian Victor Devereux, Sawston (GB); Andreas Due Engh-Halstvedt, Trondheim (NO); Mark Underwood, Cambridge (GB); Nicholas John Nelson Murphy, Farnham (GB)

(73) Assignee: Arm Limited, Cambridge (GB)

(21) Appl. No.: 18/956,234

(22) Filed: Nov. 22, 2024

(30) Foreign Application Priority Data
Nov. 29, 2023 (GB) 2318207.4

(51) Int. Cl. G06F 9/50

(52) U.S. Cl. CPC G06F 9/5077; G06F 9/5022

(57) ABSTRACT

Data processing systems, methods, computer program products, devices, and graphics processors are provided that substantially remove, or reduce, latencies introduced or incurred by a (host) processor e.g. a central processing unit (CPU), during virtualisation, in which virtual machines that are operable to execute on the (host) processor are scheduled or assigned to the graphics processor in a time-slice manner.

The present technique relates to data processing systems and in particular to data processing systems that include a graphics processing unit (GPU).

In order to increase performance of data processing systems which include at least a Central Processing Unit (CPU) and a Graphics Processing Unit (GPU), the Applicants have previously developed a virtualisation concept. The virtualisation concept exposes multiple execution environments, in the form of Virtual Machines (VMs) on the CPU. The GPU of the device can then be shared between the multiple VMs through a process called time-slicing, in which the execution capability of the GPU, i.e. graphics data processing, can be assigned and re-assigned to each VM in turn, or as required.

Typically, an arbiter is used to configure and control access by virtual machines to the graphics processor, where the arbiter is implemented in a control (host) VM. The time-slicing process requires the yielding VM to be scheduled by the arbiter of the control (host) VM on the CPU to suspend work, and the resuming or newly starting VM to be scheduled by the arbiter of the control (host) VM on the CPU to initialize the GPU and submit any pending/previously submitted work. Thus, the existing virtualisation concept relies on the CPU to at least yield the existing allocated VM from the GPU and to schedule a VM to utilise the GPU. Therefore, if the CPU scheduling takes a significantly long time to either yield or schedule VMs due to various factors, such as CPU load, multiple VMs, long running interrupt handlers, or other CPU tasks, then this CPU scheduling latency can significantly impact the performance of the data processing system. This latency within the CPU in the virtualisation concept may result in a loss of performance, as the GPU will be idle during the delay time period. Furthermore, when the VM that is yielding the GPU is no longer assigned to a CPU, but the arbiter is performing GPU scheduling, then there may not be sufficient time for the yielding VM to be scheduled back on the CPU to correctly yield the GPU. This leads to a loss in Quality-of-Service, as there may be a time-out implemented on the yield process, after which if a VM has not yielded in time the GPU is forcibly re-assigned, potentially resulting in the processes using the GPU to crash and a potential loss of data.

The inventors have recognised therefore that there remains scope for improvement to data processing systems that utilise the virtualisation concept.

According to a first aspect of the present technique, there is provided a data processing system comprising: at least one processor, wherein each processor is operable to execute one or more virtual machines; at least one graphics processor operable to perform one or more graphics processing time-slices; and an arbiter operable to assign a graphics processing time-slice to the one or more virtual machines; wherein each graphics processor comprises: a graphics processing unit instance, wherein the graphics processing unit instance is operable to perform graphics processing for the assigned virtual machine during the assigned graphics processing time-slice; and a management component operable to facilitate one or more signals between the one or more virtual machines, the arbiter and/or the graphics processor; and wherein the graphics processing unit instance is further operable to suspend the graphics processing time-slice for the assigned virtual machine in response to a suspend trigger generated by the management component in response to a signal from the arbiter.

The present technique generally relates to data processing systems that include at least one (host) processor, preferably a Central Processing Unit (CPU), and at least one graphics processor, preferably a graphics processing unit (GPU). The graphics processor comprises a management component and a graphics processing unit instance, (GPU instance), wherein the GPU instance, preferably executes graphics processing work on the graphics processor, e.g. graphics rendering for the one or more applications related to the one or more virtual machines. The management component and/or the GPU instance are preferably implemented by one or more of hardware, software, firmware, and circuitry. The graphics processor may contain any other suitable and desired components, units and elements, etc., e.g., and preferably, that a graphics processor may normally include to perform graphics data processing.

In preferred embodiments, the graphics processor is operable to remove, substantially remove, or remove at least part of, the latencies introduced or incurred by a (host) processor e.g. a central processing unit (CPU), during virtualisation, in which virtual machines that are operable to execute on the (host) processor are scheduled or assigned to the graphics processor in a time-slice manner, e.g. assigning or scheduling each virtual machine in turn to the graphics processor, e.g. GPU. Furthermore, in preferred embodiment, the data processing system prevents data loss and/or a crash of the applications executing in the virtual machines as a virtual machine yielding the graphics processor is no longer dependent on the (host) processor.

The graphics processor, e.g. GPU, is operable to perform a suspension (e.g. perform suspend tasks) of a scheduled or assigned graphics processing time-slice preferably once the scheduled or assigned time-slice for a given virtual machine is to be yielded, e.g. once a given time has elapsed. By performing the suspension of the virtual machine by the graphics processor, the associated CPU scheduling latency relating to the suspend of the virtual machine can be removed thereby enhancing the performance and efficiency of the data processing system. Furthermore, by enabling the graphics processor, e.g. GPU, to perform the suspend tasks improves the robustness as delays in CPU scheduling that causes the GPU instance to not yield in time, resulting in data loss and a potential crash of the process utilising the graphics processor, to advantageously be avoided.

In preferred embodiments, as the graphics processor is operable to perform the suspension of the yielding virtual machine, the graphics processor can perform the associated suspend tasks, which preferably include one or more of suspending each process executing on the GPU instance relating to the graphics processing for the assigned virtual machine, writing the current state of the GPU instance operations, or tasks, associated with the graphics processing for the assigned virtual machine to the memory, for example, into “suspend buffers”, writing a current execution state of the GPU instance relating to the graphics processing for the assigned virtual machine to the memory, and flushing any caches associated with the GPU instance relating to the graphics processing for the assigned virtual machine.

In preferred embodiments, the management component is preferably further operable to receive an interrupt signal, e.g. via one or more registers or commands, from the arbiter, and forward the interrupt signal, e.g. via one or more registers or commands, to the GPU instance, preferable the MCU of the GPU instance, wherein the GPU instance is preferably further operable to, on receipt, or on detection, of the interrupt signal, perform the suspension of the graphics processing time-slice for the assigned virtual machine. In preferred embodiments the arbiter may be any suitable and desired element or component that is able to configure and control access by virtual machines to the graphics processor, in other words, the arbiter may preferably be operable to schedule, or assign, a virtual machine to the graphics processor, e.g. preferably the GPU instance. In a preferred embodiment the arbiter is any suitable software that is executing on a virtual machine, more preferably on a control (host) virtual machine, that is executing on a (host) processor (e.g. on the CPU) of the data processing system. In other embodiments, the arbiter may be any suitable software that is executing on the graphics processor, e.g. a GPU, and preferably the management unit, in which case the arbiter may itself execute as, or as part of, the graphics processor, e.g. the GPU. Thus, any description hereinbelow of the functionality of an arbiter implemented by a control (host) virtual machine executing on the CPU would equally apply to an arbiter implemented on the graphics processor, e.g. the GPU, and preferably on the management component.

In preferred embodiments the GPU instance is preferably further operable to signal, e.g. via one or more registers or interrupts, the arbiter, preferably via the management component, on completion of the suspension of the graphics processing time-slice for the assigned virtual machine, and wherein the management component, on receipt of the signal, is preferably further operable to trigger an unassignment of the GPU instance, from the assigned virtual machine, and to clear a state of the GPU instance, such that the GPU instance can preferably be assigned to a further virtual machine of the one or more virtual machines, e.g. scheduled, to the GPU instance, during a further time-slice.

In preferred embodiments, the arbiter is preferably further operable to perform an atomic action to signal the management component to switch from the assigned virtual machine to a further virtual machine of the one or more virtual machines prior to the graphics processing unit instance performing the suspension of the graphics processing time-slice for the assigned virtual machine.

In preferred embodiments, the management component is preferably further operable to store a state of one or more virtual machines, and to initialise, based on the stored state of the assigned virtual machine, the GPU instance, so that the GPU instance can perform graphics processing for the assigned virtual machine during the processing time-slice.

In preferred embodiments, the processor, e.g. the CPU, may be operable to execute a controller virtual machine and wherein the arbiter may be at least part of the controller virtual machine.

In preferred embodiments, the arbiter may be at least part of the graphics processor, e.g. GPU, and more preferably at least part of the management component.

In preferred embodiments, the management component and/or the graphics processor unit instance comprise hardware, software, firmware, or any combination thereof.

According to a second aspect of the present technique there is provided a method of operating a data processing system. According to a third aspect of the present technique there is provided a computer program product comprising computer readable executable code. According to a fourth aspect of the present technique there is provided a device. According to a fifth aspect of the present technique there is provided a graphics processor.

According to a sixth aspect of the present technique there is provided a data processing system comprising: at least one processor, wherein each processor is operable to execute one or more virtual machines; at least one graphics processing unit operable to perform one or more graphics processing time-slices; and at least one arbiter, wherein each arbiter is operable to assign a graphics processing time-slice to the one or more virtual machines; wherein each graphics processing unit comprises: a graphics processing unit instance, wherein the graphics processing unit instance is operable to perform graphics processing for the assigned virtual machine during the assigned graphics processing time-slice; and a management component operable to facilitate one or more signals between the one or more virtual machines, the arbiter and/or the graphics processing unit; and wherein the at least one arbiter is operable to signal the management component, wherein the signal is indicative of a further virtual machine to be assigned to the graphics processing unit instance during a next graphics processing time-slice, prior to completion of a suspension of the assigned virtual machine from the graphics processing unit instance.

In preferred embodiments the arbiter can signal the management component of the GPU to effectively assign the next virtual machine prior to, e.g. before, the suspension of the currently assigned virtual machine from the GPU instance.

In embodiments, the at least one arbiter may be operable to perform an atomic operation to both signal a suspension of the assigned virtual machine from the graphics processing unit instance and to provide the signal indicative of a further virtual machine to be assigned to the graphics processing unit instance during a next graphics processing time-slice.

In embodiments, the signal indicative of the further virtual machine may include an access window of the further virtual machine. In embodiments, the management component may be operable to assign the further virtual machine to the graphics processing unit instance during a next graphics processing time-slice.

According to a seventh aspect of the present technique there is provided a graphics processor. According to an eighth aspect of the present technique there is provided a method of operating a data processing system of the sixth aspect and/or a graphics processor of the seventh aspect. According to a ninth aspect of the present technique there is provided a computer program product comprising computer readable executable code for implementing the method of the eighth aspect. According to a tenth aspect of the present technique there is provided a device comprising a data processing system of the sixth aspect.

According to an eleventh aspect of the present technique there is provided a data processing system comprising: a memory; at least one processor, wherein each processor is operable to execute one or more virtual machines; at least one graphics processing unit operable to perform one or more graphics processing time-slices; and at least one arbiter, wherein each arbiter is operable to assign a graphics processing time-slice to the one or more virtual machines; wherein each graphics processing unit comprises: a graphics processing unit instance, wherein the graphics processing unit instance is operable to perform graphics processing for the assigned virtual machine during the assigned graphics processing time-slice; and a management component operable to facilitate one or more signals between the one or more virtual machines, the arbiter and/or the graphics processing unit; wherein the graphics processing unit instance is further operable to store in the memory state information relating to one or more virtual machines; and the graphics processing unit instance is further operable to initialise the graphics processing time-slice for the assigned virtual machine based on the stored state information.

In preferred embodiments, the GPU instance, e.g. the MCU of the GPU instance, can store state information relating to one or more of the virtual machines to effectively enable the GPU instance to initialise based on the stored state information. As such, the state information relating to a virtual machine, wherein the state information may relate to a resumption of previous graphics data processing work for a given virtual machine or new graphics data processing work for a given virtual machine, can be utilised to initialise the GPU instance.

In embodiments, the memory may be internal and/or external to the GPU.

In embodiments, the graphics processing unit instance may be operable to store one or more pointers to the state information stored in the memory. This may be advantageous if an external memory to the GPU is used to store the state information as the amount of memory internal to the GPU may be minimised, or more effectively utilised, by storing one or more pointers to the state information for each virtual machine.

According to a twelfth aspect of the present technique there is provided a graphics processor. According to a thirteenth aspect of the present technique there is provided a method of operating a data processing system of the eleventh aspect and/or a graphics processor of the twelfth aspect. According to a fourteenth aspect of the present technique there is provided a computer program product comprising computer readable executable code for implementing the method of the thirteenth aspect. According to a fifteenth aspect of the present technique there is provided a device comprising the data processing system of the eleventh aspect.

A number of preferred embodiments of the present technique will now be described by way of example only and with reference to the accompanying drawings, in which:

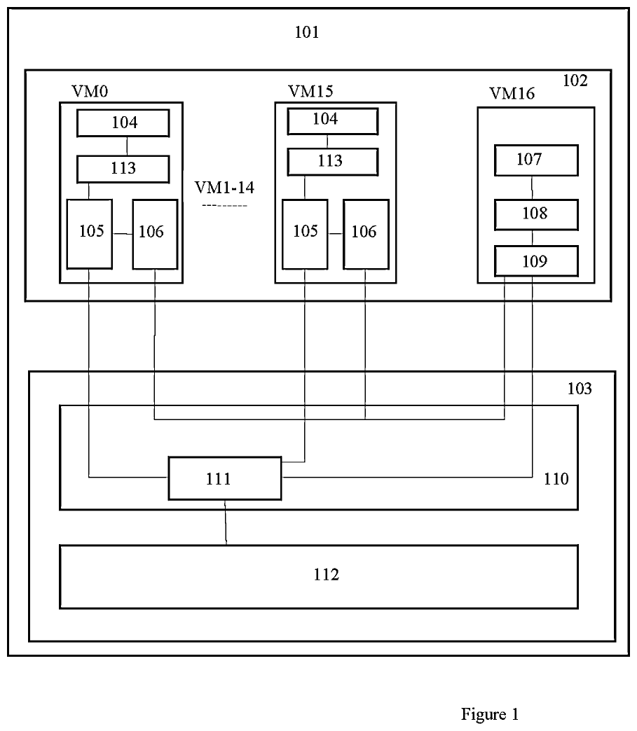

FIG. 1 illustrates a simplified schematic of a data processing system, according to one or more embodiments of the present disclosure.

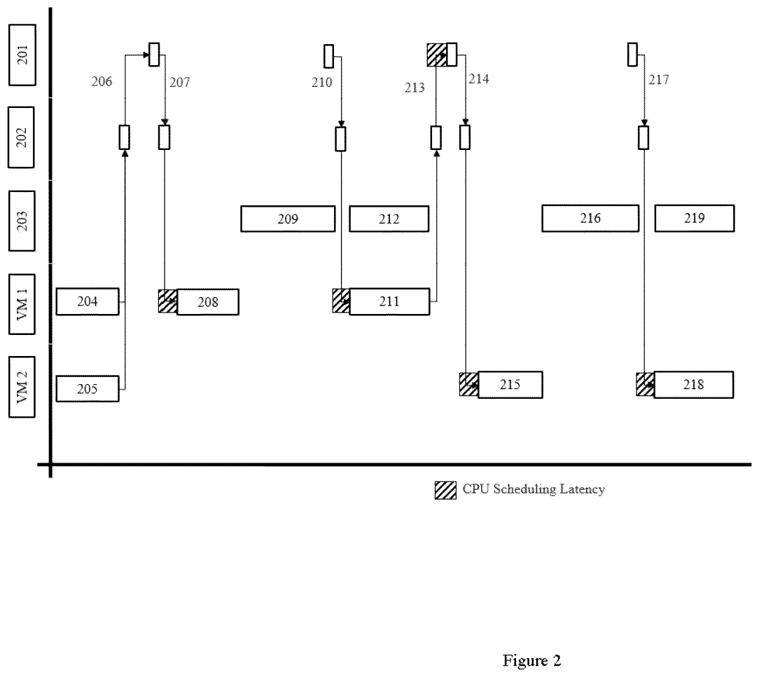

FIG. 2 illustrates schematically a flow diagram of a conventional virtualisation process.

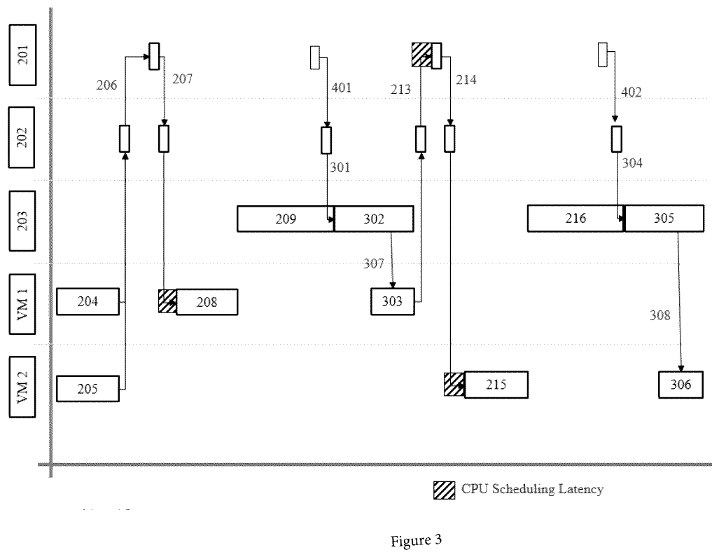

FIG. 3 illustrates schematically a flow diagram of a virtualisation process according to one or more embodiments of the present disclosure.

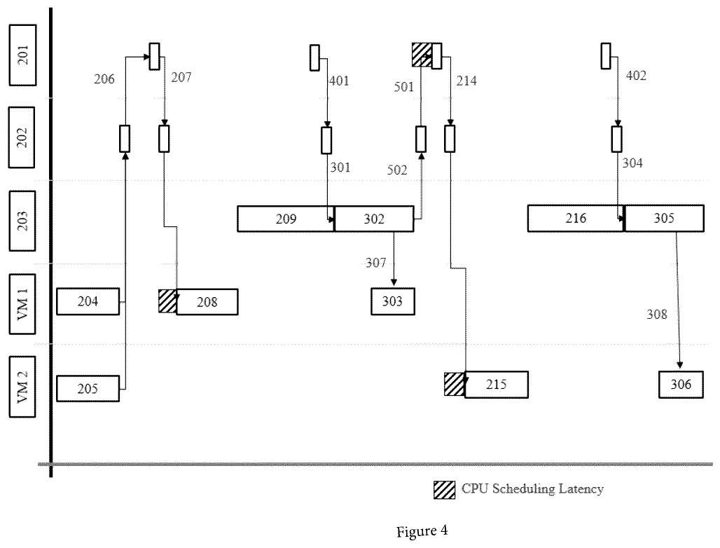

FIG. 4 illustrates schematically a flow diagram of a virtualisation process according to one or more embodiments of the present disclosure.

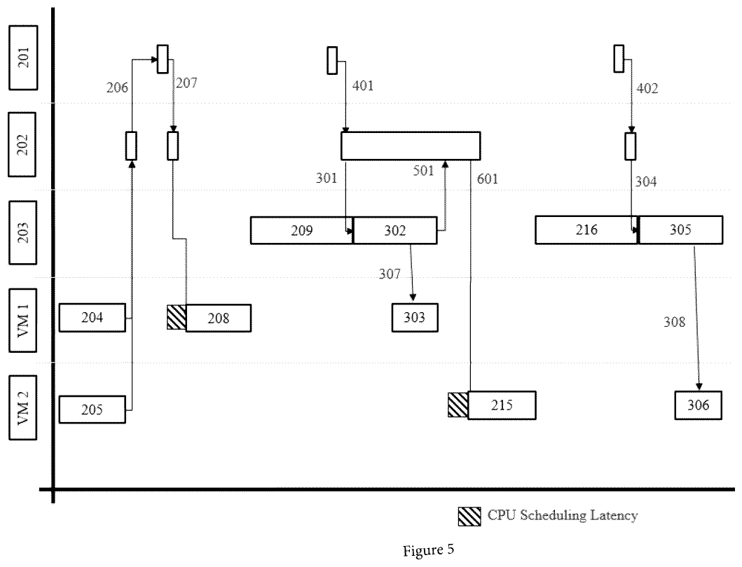

FIG. 5 illustrates schematically a flow diagram of a virtualisation process according to one or more embodiments of the present disclosure.

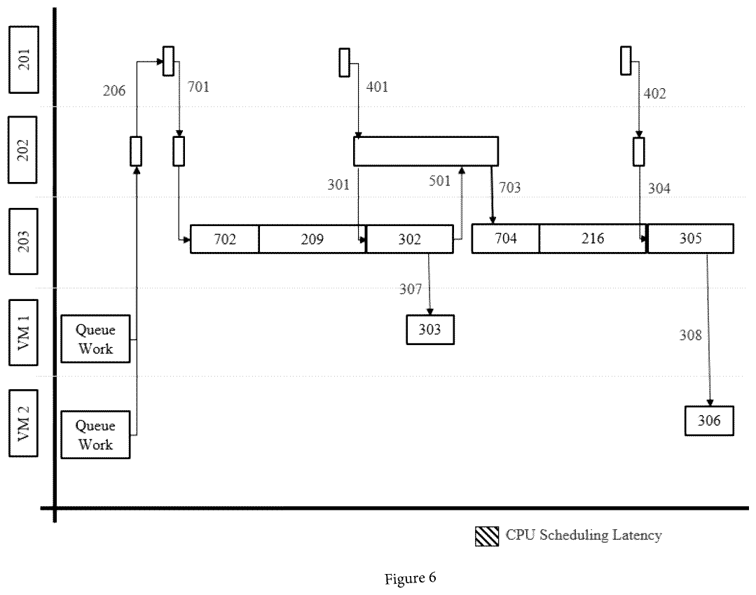

FIG. 6 illustrates schematically a flow diagram of a virtualisation process according to one or more embodiments of the present disclosure.

FIG. 1 shows a simplified schematic of a data processing system 101 which includes a (host) processor 102, e.g. a CPU, and a data processing unit 103, e.g. a Graphics Processing Unit (GPU). As will be appreciated, the data processing system 101 may include any number of further or additional suitable circuits and/or components in order to implement the present technique, for example, memory, controllers, additional processors, and so on. The data processing system 101 may be implemented as part of any suitable electronic device which may be required to perform graphics processing, e.g., such as a desktop computer, a portable electronic device (e.g. a tablet or mobile phone), or other electronic device. Thus, the present technique also extends to an electronic device that includes the data processing system 101 of the present technique (and on which the data processing system operates in the manner of the present technique). The data processing system of the present technique may, in an embodiment, be implemented as part of a portable electronic device (such as a mobile phone, tablet, or other portable device). The data processing system of the present technique may, in an embodiment, be implemented as part of an automotive system, for example, vehicles may have a display screen for the main instrument console, an additional navigation and/or entertainment screen, and an advanced driver assistance system (ADAS).

The CPU 102 of the data processing system 101 is operable to execute a set of virtual machines (VMs) VM0 to VM16, according to one or more preferred embodiments. However, as will be appreciated, there may be any number, e.g. one or more, virtual machines that may be executing on the CPU of a given data processing system.

Preferably, one of the virtual machines may be implemented as a controller (host) virtual machine, e.g. VM16 in FIG. 1. The controller (host) virtual machine VM16 may include a GPU Policy component 107, an arbiter 108, and a management component driver 109. The arbiter 108 preferably being operable to control access by virtual machines VM0 to VM15, to the data processing unit 103, e.g. GPU instance.

The arbiter 108 may be any suitable and desired element or component that is able to configure and control access by virtual machines to the data processing unit.

In a preferred embodiment, the arbiter 108 is any suitable software that is executing on, or as part of, a virtual machine, preferably executing in a control (host) virtual machine, that is executing on the processor 102 (e.g. on the CPU) of the data processing system 101, as shown in FIG. 1. Alternatively, as mentioned hereinabove, the arbiter may be any suitable software that is executing on the data processing unit, e.g. a GPU, in which case the arbiter may itself execute as, or as part of, the data processing unit, e.g. the GPU.

Virtual machines VM0 to VM15 may preferably include an application 104, wherein the application 104 may be the same application or a different application in each of the virtual machines. In FIG. 1, each virtual machine is shown with a single application 104, however, as will be appreciated each virtual machine may include any number of applications, each of which may require graphics data processing on the data processing unit, e.g. the GPU instance.

The application (or applications) 104 preferably operatively communicate with a Driver Development Kit (DDK) 113 of the virtual machine, which in turn is preferably operatively communicates with a GPU Kernel Driver 105 of the virtual machine. The GPU Kernel Driver 105 preferably operatively communicates with an Access Window Driver 106 of the virtual machine. The GPU Kernel Driver 105 may also preferably operatively communicate with the data processing unit 103, e.g. GPU instance (112), preferably via a multiplexer 111 of the management component 110. The Access Window Driver 106 may preferably operatively communicate with the management component driver 109, which is preferably implemented via the management component 110.

The data processing unit 103, e.g. the GPU, includes, or is associated with, a management component 110, which may also be referred to as an access manager or a partition manager. The management component 110 may preferably include a multiplexer 111 to multiplex signals from the virtual machines to provide access to a GPU instance 112. The data processing unit 103, e.g. the GPU, includes a GPU instance 112, which may also be referred to as a GPU slice. The GPU instance 112 may include all of the necessary hardware, circuitry, software, firmware, and/or components to implement the required graphics data processing for the virtual machines, e.g. fragment processing, rendering, and so on. The GPU instance 112 preferably includes a microcontroller (MCU).

The data processing unit 103, e.g. GPU, can preferably be any suitable and desired graphics processor that includes a programmable execution unit operable to execute (shader) programs to perform processing operations. The graphics processor may otherwise be configured and operable as desired, and be configured to execute any suitable and desired form of graphics processing pipeline (in its normal graphics processing operation). Graphic processors and graphics processing is well known in the art and as such will not be described herein in detail.

In order to facilitate communication and signals between the data processing unit 103, the arbiter 108 and the virtual machines VM0 to VM15, the management component 110 of the data processing unit 103 preferably includes, or provides, one or more “access windows”, to provide the mechanism by which virtual machines can access and control the data processing unit (when they require processing by the data processing unit).

These access windows may comprise respective sets of addresses (address ranges) which a virtual machine can use to communicate with the data processing unit. Each access window may comprise a range of physical addresses that can be used to access a communications interface, and preferably a set of “communications” registers, to be used to communicate with (and control) the data processing unit (which physical addresses will then be mapped into the address space of the (host) data processing system processor, e.g. CPU, on which the virtual machine is executing, to allow the virtual machine to address the data processing unit).

Each access window thus preferably corresponds to a “physical” communications interface (and preferably to a set of communications registers) that can be used by a virtual machine to communicate with and control the data processing unit, and which accordingly has a corresponding set of physical addresses that can be used to access and communicate with that communications interface. Each access window preferably also comprises and provides an interface (and preferably a (message passing) register or registers) for communications between (for messaging between) a virtual machine and the arbiter for the set of virtual machines.

Thus, the access windows may also provide the mechanism whereby a virtual machine may communicate with the arbiter, and in particular may provide a mechanism for a virtual machine and arbiter to exchange messages, for example in relation to the virtual machine requesting data processing resources, and the arbiter controlling access of the virtual machine to the data processing unit, for example to signal when the access window is enabled, and/or when the virtual machine is to relinquish its use of the data processing unit, e.g. so as to permit a different virtual machine to access the data processing unit. These communications interfaces (sets of communications registers) that provide the access windows are preferably part of a management component for the data processing unit. Thus, the management component for the data processing unit may preferably provide a set of physical communications interfaces (e.g. sets of communications registers) that can each correspondingly allow access to the data processing unit (and, preferably, also communication between a virtual machine and an arbiter).

Any communication between the arbiter and a virtual machine preferably takes place via the management component, and in particular via the communication interface (access window) allocated to the virtual machine. Thus, the virtual machines and arbiter will communicate with each other via the access windows allocated to the virtual machines (the communications interfaces for the virtual machines supported by the management component of the data processing unit).

An example of the CPU scheduling within the virtualisation concept previously developed by the Applicants is shown in FIG. 2. As can be seen in FIG. 2, two virtual machines, VM1 and VM2, have queued graphics data processing work 204 and 205 respectively for the data processing unit, e.g. the GPU instance 203. However, as will be appreciated the use of two virtual machines is an example and any number of virtual machines may queue data processing work for the GPU.

Each virtual machine, VM1 and VM2, signals 206, e.g. sends a request message, to the arbiter 201 via the management component 202 (which may also be referred to as an access manager or a partition manager, of the GPU). The arbiter schedules, or assigns, 207 a first virtual machine VM1 a time-slice access to the GPU instance 203, utilising, or via, an access window provided by the management component 202.

In FIG. 2, VM1 is initially scheduled, or assigned, a first time-slice access to the GPU instance 203 and a CPU of the data processing system executing VM1, schedules VM1 to boot, or initialise, the GPU 208 with the required data and parameters for the graphics data processing work required by VM1, which introduces a CPU scheduling latency. The GPU instance 203 subsequently performs the graphics data processing for VM1 during its scheduled or assigned time-slice 209. At the end of the assigned time-slice the arbiter 201 signals 210 VM1 executing on the CPU, via the management component 202, to schedule the suspension of the GPU instance for VM1. VM1, via the CPU, performs 211 the suspension of VM1 on the GPU instance such that VM1 is unassigned 212 from the GPU instance, which introduces an additional CPU latency. Furthermore, if VM1 is not unassigned in time from the GPU instance this can lead to the application executing in VM1 crashing and a loss of data.

On completion of the suspension of the GPU instance for VM1, VM1, executing on the CPU, signals 213 the arbiter 201 via the associated access window provided by the management component 202 of the completed suspend task to enable the arbiter 201 to schedule, or assign 214 VM2, executing on the CPU, the second time-slice access to the GPU instance 203, via an access window provided by the management component 202. The scheduling of VM2 by the arbiter on the CPU again potentially introduces a further CPU scheduling latency. The process is repeated for VM2 meaning that further CPU scheduling latencies are caused by the boot, or initialisation, of the GPU instance 215 for the graphics data processing work requested by VM2 and performed 216 by the GPU instance 215, and for the suspend task 217, 218, 219 triggered and performed by VM2 executing on the CPU, once the second time-slice for the GPU instance scheduled or assigned to VM2 for the graphics data processing has elapsed.

Accordingly, as can be seen in FIG. 2, the use of the CPU in scheduling, or assigning, each virtual machine a time-slice of graphics data processing by the GPU instance and subsequently each virtual machine, via the CPU, performing the suspend task for each virtual machine once the allocated time-slice has elapsed can add significant latencies, which may cause significant performance issues including a lack of efficiency of utilisation of the GPU, as described above.

In other words, the requirement for the assigned virtual machine, via the CPU upon which the virtual machine is executing, to both assign to and yield from the data processing unit, e.g, GPU instance, can potentially lead to both significant delays and a loss in performance, for example, resulting from a potential crash of the application executing in the virtual machine and the associated data loss. The inventors have recognised that an improvement to the virtualisation concept can be made by, essentially, removing the dependency on CPU scheduling in the virtualisation process.

As discussed above, in preferred embodiments, the data processing unit, e.g. the GPU, is enabled to perform the functionality of implementing the suspend task(s) for any virtual machine that is currently assigned a time-slice for GPU data processing. Thus, the GPU itself is operable to suspend each process executing on the GPU, write out, for example to memory (e.g. suspend buffers), any pending counters, and to write, for example to memory, the current execution state of the GPU instance. As such, by providing the GPU with the ability to perform the required suspend tasks for a yielding virtual machine, the dependency on the virtual machine, executing on and using the CPU, in relation to the suspend task can be removed.

In other words, in preferred embodiments, the suspend tasks to unassign VM1 from the GPU instance are no longer coordinated by VM1 executing on the CPU but, in contrast, are coordinated and performed by the GPU, e.g. the suspend tasks functionality is incorporated into the GPU. As discussed hereinabove, the arbiter may be executed by a control (host) virtual machine executing on the CPU or, alternatively, the arbiter may be at least part of the data processing unit, for example, executed by the management component 202.

The inventors have recognised that further additional improvements to the virtualisation process can be made, as will be discussed in relation to FIGS. 3 to 6.

A first extension will now be described with reference to FIG. 3. The first extension enables the arbiter 201, via an access window provided by the management component 202, to signal an interrupt 401 directly to the GPU, for example to the GPU instance 203, and preferably the MCU of the GPU instance. In preferred embodiments, this first extension provides two changes to the architecture by, firstly, providing, or extending, a dedicated arbiter interface provided by the management component 202 to include an additional yield command register, and secondly providing an interrupt, preferably a hardware signal, directly to the GPU instance, preferably the MCU of the GPU instance, automatically once the yield command is set, or sent, by the arbiter to the dedicated arbiter interface provided by the management component 202.

The advantageous implementation and message flow of the first extension to the virtualisation process of preferred embodiments is shown in FIG. 3, where the same reference numerals as given in FIG. 2 are used where appropriate. FIG. 3 shows the same two virtual machines, VM1 and VM2, which have queued graphics data processing work 204, 205 respectively for the data processing unit, e.g. preferably the GPU and more preferably the GPU instance 203. FIG. 3 follows the same virtualisation process as shown in FIG. 2 of scheduling 207 VM1 to access the GPU instance for the respective time-slice.

However, in FIG. 3, on detection by the management component 202 of an interrupt signal 401 from the arbiter 201, which in preferred embodiments is via a yield command in a dedicated arbiter interface, the management component signals, preferably as a hardware signal, the GPU instance 203 to perform the necessary suspend task(s) 302 in order to suspend the graphics data processing for the current virtual machine, e.g. VM1 in FIG. 3.

Thus, the GPU instance 203, preferably the MCU of the GPU instance, performs the necessary suspend task(s) 302 for VM1, so as to unassign VM1 from the GPU instance, without involvement of VM1 that is executing on the CPU, thereby removing the associated CPU scheduling latency and dependency on the CPU, which was shown in FIG. 2. In FIG. 2, the arbiter signals, via the access window associated with VM1 provided by the management component of the GPU, VM1 executing on the CPU that the time-slice assigned to VM1 has elapsed, which causes VM1, via the CPU on which VM1 is executing, to perform the suspend tasks to unassign VM1 from the GPU instance. In contrast, and as shown in FIG. 3, once the management component 202 receives the signal from the arbiter, e.g. via the yield command to the dedicated arbiter interface of the management component, indicating VM1 is to yield the GPU instance, e.g. that the time-slice assigned to VM1 has elapsed, the management component 202 directly signals, e.g. via a hardware signal, the GPU instance, preferably the MCU of the GPU instance, to initiate and perform the suspend tasks to unassign VM1 from the GPU instance.

Thus, the suspend tasks to unassign VM1 from the GPU instance are no longer coordinated by VM1 executing on the CPU but, in contrast, are coordinated and performed by the GPU instance.

The first extension is advantageous as there is no requirement to send a signal, e.g. a message, to the yielding virtual machine, via the virtual machine access window, from the arbiter to schedule the unassignment of the virtual machine from the GPU instance. However, in embodiments, it may be useful to inform the virtual machine that it is being unassigned from the GPU instance. Therefore, the management component may signal the virtual machine, preferably by an interrupt e.g. via the access window of the virtual machine, to inform the virtual machine that it is being unassigned from the GPU instance. The virtual machine may be signalled by the management component substantially at the same time as, or shortly thereafter, the management component detects the interrupt from the arbiter to perform the suspend task(s). In response to receiving or detecting the signal, e.g. interrupt, from the management component, the virtual machine may, or may not, perform any actions or operations. However, as the virtual machine has been removed from the critical path then any actions/operations performed by the virtual machine will not delay, or prevent, the suspend process being performed by the GPU.

As described above, the GPU instance, preferably the MCU of the GPU instance, performs the suspend task(s) 302 for VM1 to unassign the virtual machine from the GPU instance. In preferred embodiments, the GPU, signals 307 VM1, preferably by an interrupt e.g. via the access window of the virtual machine, to inform VM1 that the suspend task(s) 302 performed by the GPU instance to unassign VM1 from the GPU instance, have been completed. In embodiments, VM1, on detecting or receiving the signal, e.g. an interrupt, raised by the GPU instance, preferably the MCU of the GPU instance, may perform one or more operations 303, e.g. sync tasks, due to VM1 now being unassigned from the GPU instance. VM1 on completion of any operations 303, e.g. sync tasks, may then signal the arbiter, e.g. via VM1's access window provided by the management component, enabling the arbiter to subsequently assign a further virtual machine, e.g. VM2, to the GPU.

The first extension is preferably replicated for VM2 in that the arbiter 201, via the management component 202, signals an interrupt 402 directly to the GPU instance, preferably via the dedicated arbiter interface and the hardware signal as discussed hereinabove, wherein on receipt of the interrupt signal the GPU instance 203 performs the necessary suspend tasks 305 in order to suspend the graphics data processing for the current virtual machine. In preferred embodiment, the management component 202 may additionally, or simultaneously, signal VM2, e.g. via an interrupt, to inform VM2 that it's graphics data processing tasks are being suspended by the GPU instance. On completion of the suspend task(s) 305, the GPU instance, preferably the MCU of the GPU instance, may signal 308, e.g. via an interrupt, VM2 to inform VM2 that the suspend tasks have been completed. VM2, on detecting or receiving the signal, e.g. an interrupt, raised by the GPU instance, preferably the MCU of the GPU instance, may perform one or more operations 306, e.g. sync tasks, due to VM2 now being unassigned from the GPU instance.

A second extension will now be described with reference to FIG. 4, in which the GPU instance, preferably the MCU of the GPU instance, is enabled, or operable, to directly signal the management component of the GPU on completion of the suspend tasks. In preferred embodiments, the signal is implemented via a new command which is passed to a register of an interface between the GPU instance and the management component. The signal on completion of the suspend tasks enables the management component to trigger an unassign process of the GPU instance, for example, close the access window associated with the yielding virtual machine. Preferably, the triggered unassign process may further include clearing all states of the GPU instance in preparation for a further virtual machine to be scheduled, or assigned, to the GPU instance in a further time-slice, in other words reset the GPU instance. The management component may also send a new interrupt signal to the arbiter via the dedicated arbiter interface to inform the arbiter that the GPU instance has been unassigned from the virtual machine and the suspend tasks have been completed.

In FIG. 4, the same reference numerals as given in FIG. 3 are used where appropriate, and shows the same two virtual machines, VM1 and VM2, which have queued data processing work 204, 205 respectively for the data processing unit, e.g. the GPU instance 203. FIG. 4 follows the same virtualisation process as shown in FIG. 3 of scheduling VM1 to access the GPU instance for the respective time-slice and up to performing the suspend tasks in relation to VM1. In FIG. 4, on completion of the suspend tasks by the GPU instance, the GPU instance directly signals 502 the management component 202, e.g. via a new command which is passed to a register of an interface between the GPU instance and the management component, indicating the completion of the suspend tasks to enable the management component 202 to perform an unassignment process of the GPU instance. The management component sends an interrupt signal 501 to the arbiter to indicate the completion of the suspend tasks. In contrast, as shown in FIG. 2, the management component is signalled by the yielding virtual machine which was performed via a generic message passing interface, e.g. the access windows. However, in order for the yielding virtual machine to signal the arbiter, via the management component 202, the yielding virtual machine needs to be scheduled on the processor (host) CPU. Thus, if the scheduling by the CPU of the yielding virtual machine to transmit the completion signal to the arbiter includes any latencies, e.g. due to other tasks the CPU is currently handling, then effectively GPU processing time is wasted as the GPU would be idle during the CPU latency and further delays the switch process to assign a different virtual machine to the GPU instance. Thus, this second extension advantageously removes the dependency on the CPU for the arbiter to be signalled on completion of the suspend tasks for the yielding virtual machine, as, on completion of the suspend tasks for the yielding virtual machine, the GPU, e.g. the GPU instance, directly signals the arbiter, via the management component.

A third extension will now be described in relation to FIG. 5. The third extension enables the arbiter to indicate to the management component the next assigned virtual machine prior to, or during, the suspension of the currently assigned virtual machine from the GPU instance, by preferably sending a signal indicative of the next, or further, virtual machine to be assigned to the management component, preferably via the dedicated arbiter interface. In other words, the arbiter can effectively auto-assign the next virtual machine that will access the GPU instance prior to, or before, the completion of the suspension of the currently assigned virtual machine from the GPU instance.

For example, in preferred embodiments, the arbiter may perform a single atomic action to signal the management component that the GPU instance is to be switched from the yielding virtual machine to a further virtual machine that is to be assigned to the GPU instance during a subsequent time-slice. In other words, the arbiter can both signal the management component to yield the currently assigned virtual machine and to indicate the next virtual machine that is to be assigned during the next time slice. Preferably, the arbiter signals, e.g. by the single atomic action, the management component of the GPU that the GPU instance is to be switched from a first access window corresponding to the yielding virtual machine to a second access window corresponding to a further virtual machine that is to be assigned to the GPU instance during the next time-slice. Thus, this third extension may be considered to effectively “pre-program” the next virtual machine to be assigned to the GPU instance in the sense that the arbiter, preferably via the single atomic action, sets the access window for the virtual machine that is to be assigned to the GPU instance prior to, or during, the current virtual machine yielding from the GPU instance.

This third extension may preferably be implemented as an extension of the previously described embodiments in which the GPU performs the suspend task(s), the first extension and/or the second extension, in that during the current unassign process, or on the next unassign process, the access window for the next virtual machine can be set by the arbiter.

However, as will be appreciated, this third extension may alternatively be implemented in it's own right, for example, as a performance improvement to the conventional virtualisation process as described in relation to FIG. 2. As described above, in the conventional virtualisation process, the arbiter signalled the virtual machine, utilising the virtual machines access window provided by the management component, to schedule the suspend tasks. Thus, in embodiments, the arbiter may also signal, substantially at the same time as signalling the virtual machine to schedule the suspend task(s), e.g. by performing a single atomic action, or during the performance of the suspend task(s) scheduled by the virtual machine, the management component to indicate the next, or further, virtual machine that is to be assigned during the next time slice, wherein the signal may include, or indicate, the access window of the next, or further, virtual machine to be assigned. Thus, once the management component detects, or receives, the signal from the virtual machine once the suspend tasks are completed, the management component may assign and signal a further virtual machine to the GPU instance.

In all implementations described above of this third extension, the third extension advantageously provides that the arbiter, utilising the CPU, does not have to schedule the next virtual machine for the next time-slice after the GPU instance is unassigned, e.g. once the previous virtual machine has yielded the GPU instance. Accordingly, this third extension removes the dependency on the CPU to allocate a new virtual machine for the subsequent GPU instance time-slice.

In FIG. 5, the third extension is described as a further extension of the second extension described above in relation to FIG. 4. However, as discussed, the performance improvement provided by this third extension can equally apply to the embodiments described in relation to FIG. 3, or to the conventional virtualisation process described in relation to FIG. 2.

Thus, in FIG. 5 the same reference numerals as given in FIG. 4 are used, where appropriate, and FIG. 5 shows the same two virtual machines, VM1 and VM2, which have queued data processing work 204, 205 respectively for the data processing unit, e.g. the GPU instance 203. FIG. 5 follows the same virtualisation process as shown in FIG. 4 of scheduling VM1 to access the GPU for the respective first time-slice and up to, and including, performing the suspend tasks 302 relating to VM1. However, in FIG. 5, the arbiter can both signal an interrupt 401 to the management component 202, preferably via the dedicated arbiter interface, and set the access window of the next virtual machine, e.g. VM2 in FIG. 5, preferably via a single atomic action. The management component 202 may then automatically signal 601 VM2, based on the access window previously set by the arbiter, on completion of the suspend tasks for the yielding virtual machine, e.g. VM1 in FIG. 5, to boot, or initialise, the GPU instance with the required data and parameters for the GPU instance 215. Thus, this third extension advantageously removes the CPU dependency relating to the scheduling of the next virtual machine in the following GPU time-slice after the previous virtual machine has yielded the GPU instance. This is in contrast to FIG. 4 in which the arbiter 201, utilising the CPU, with the associated CPU scheduling latency, scheduled VM2 access to the GPU instance at the next time-slice after the GPU instance was unassigned from the previous yielding virtual machine, e.g. VM1, and the suspend tasks completed.

The third extension therefore advantageously removes the arbiter 201 from the critical path during the scheduling of the GPU instance 203 to a further virtual machine by enabling the arbiter 201 to set the access window, effectively in advance, for the next virtual machine, which enables the management component to initiate the next virtual machine automatically.

A fourth extension will now be described in relation to FIG. 6. The fourth extension enables graphics data processing by the GPU instance during a time-slice to be resumed, or initiated, without the need for the virtual machine, utilising the CPU, to boot, e.g. initialise, the GPU instance at the beginning of the given virtual machine's time-slice. In other words, the GPU can effectively auto-resume and/or auto-start the graphics data processing for a given virtual machine that will access the GPU instance. Accordingly, the CPU scheduling latency incurred in resuming, or starting, the data processing for a given virtual machine can be removed from the virtualisation process.

In preferred embodiments, the state information relating to a previously yielded virtual machine, or state information relating to new data processing required by a virtual machine, can be stored in the access window associated with the virtual machine, which ensures sufficient state information, in relation to a previously yielded virtual machine is persistent and available to the GPU. Thus, the GPU hardware can boot, e.g. initialise, the GPU instance, preferably the MCU of the GPU instance, and resume any data processing that was previously suspended during a previous yield of a virtual machine, or start any new data processing for a virtual machine.

The process may include programming one or more GPU Memory Management Units (MMUs) to enable the GPU instance, preferably the MCU of the GPU instance, access to a memory. The GPU instance, preferably the MCU of the GPU instance, is booted, e.g. initialised, using code, preferably firmware code, stored in the memory. The code, e.g. firmware code, loads the state information from the memory and, if resuming data processing for a virtual machine, a state of any previous data processing from the suspend buffers. The GPU instance is then operable to continue the execution of any data processing from the suspend buffers and/or enable the submission of new data processing from a virtual machine.

Within the GPU there is preferably a stage 1 MMU, that is utilised to translate, or map, application addresses to intermediate physical addresses (IPA) for a given virtual machine. The MMU may further include a translation, or mapping, for the MCUs accesses, for the code, the data, and the suspend buffers for a given virtual machine. In effect these translations, or mappings, define where in the memory for the given virtual machine the memory for the MMU and the applications are stored, and ensures that an incorrect memory for a given virtual machine cannot be accessed. Accordingly, in embodiments, the MMU may be programmed with page tables which define these translations, or mappings, so as to enable the MCU to execute, and for the processes to subsequently execute.

As shown in FIG. 6, in which the same reference numerals as given in FIG. 5 are used where appropriate, each time a virtual machine, e.g. VM1 and VM2 in FIG. 6, is assigned 701, 703 to the GPU instance 203 by the arbiter in cooperation with the management component 202, for example, utilising the associated access window. The GPU instance 203 subsequently performs the boot, e.g. initialisation, process 702, 704 in order to prepare the GPU instance 203 to perform the graphics data processing required by the virtual machine VM1, VM2 during their allocated time-slice. In preferred embodiments, the GPU is enabled, or operable, to store the state information required to resume, or start, graphics data processing for any given virtual machine. For example, stage-1 page tables for the resuming, or initiated, graphics data processing for any given virtual machine are typically stored in a unified memory architecture associated with the data processing system, such that the management component of the GPU may preferably store a pointer to the stage-1 page tables within a memory associated with, or internal to, the management component. In addition, the management component of the GPU may preferably also store, within a memory associated with, or internal to, the management component, any further state information, for example, any virtual machine specific hardware configuration settings, that may be required to boot, e.g. initialise, the GPU instance to perform the graphics data processing required by the virtual machine. By preferably storing the state information, and/or pointers to the state information, relating to the virtual machine that is being assigned to the GPU instance, within a memory associated with, or internal to, the management component, the information may persist across the switch between virtual machines being assigned to the GPU instance.

Furthermore, as the management component of the GPU stores the state information, and/or pointers to the state information, such that they reside within a memory associated with, or internal to, the management component, then the information for each virtual machine that is assigned to the GPU instance can effectively, and preferably, be applied automatically.

Accordingly, the GPU instance is enabled to (re-)initialise the GPU instance at the beginning of the assigned time-slice to the given virtual machine, so that the GPU instance can resume any remaining or newly submitted graphics data processing work since the given virtual machine was previously scheduled and assigned a time-slice on the GPU instance.

Accordingly, FIG. 6, in comparison to FIGS. 2 to 5, removes the dependency on the CPU, and the CPU scheduling latency incurred, during the boot process for each virtual machine at the beginning of the given virtual machine's allocated time slice on the GPU instance.

As will be appreciated, this fourth extension may preferably be implemented as an extension of the previously described embodiments in which the GPU performs the suspend task(s), the first extension, the second extension, and/or the third extension.

However, as will be appreciated, this fourth extension may alternatively be implemented in it's own right, for example, as a performance improvement to the conventional virtualisation process as described in relation to FIG. 2. As described above, in the conventional virtualisation process, the arbiter signalled the virtual machine, utilising the virtual machines access window provided by the management component, to schedule the first virtual machine VM1 a time-slice access to the GPU instance, wherein the CPU of the data processing system executing VM1, schedules VM1 to boot, e.g. initialise, the GPU with the required data and parameters for the graphics data processing work required by VM1. In contrast, in embodiments of the fourth extension the GPU instance performs the boot process in order to initialise the GPU instance to perform the graphics data processing required by the virtual machine VM1 during their allocated time-slice, as described above,

FIG. 6 also shows the combination of all of the above described first through fourth extensions and, by utilising or implementing a combination of all of the first through fourth extensions, all of the previous CPU scheduling latencies and CPU dependencies, as shown in FIG. 2, have been removed from the data processing system. However, as will be appreciated, not all of the extensions are required to be implemented in combination in order to reduce the CPU scheduling latencies and CPU dependencies. As such, in preferred embodiments one or more of the first through fourth extensions may be implemented, in any combination, in order to remove at least part of the CPU scheduling latencies from the data processing system and/or to provide performance improvements.

By implementing one or more of the above-described embodiments, a significant increase in performance of the data processing system can be achieved.

In the above-described embodiments, the data processing system preferably includes a single data processing unit, e.g. GPU. However, as will be appreciated, the data processing system may include any number, e.g. one or more, GPUs each being provided with the functionality of one or more of the extensions described hereinabove. Similarly, the data processing system in the above-described embodiments includes a single CPU on which any number of virtual machines are provided or executed. However, as will be appreciated, the data processing system may include any number, e.g. one or more, CPUs each providing or executing any number of virtual machines that can be allocated, or scheduled, to the one or more GPUs.

It will also be appreciated by those skilled in the art that all of the described embodiments of the present technique may include, as appropriate, any one or more or all of the features described herein.

The methods in accordance with the present technique may be implemented at least partially using software e.g. computer programs. It will thus be seen that when viewed from further embodiments the present technique comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The present technique also extends to a computer software carrier comprising such software which when used to operate a data processing system causes in a processor, or system to carry out the steps of the methods of the present technique. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the present technique need be carried out by computer software and thus from a further broad embodiment the present technique comprises computer software and such software installed on a computer software carrier for carrying out at least one of the steps of the methods set out herein.

The present technique may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

1. A data processing system comprising:
at least one processor, wherein each processor is operable to execute one or more virtual machines;
at least one graphics processing unit operable to perform one or more graphics processing time-slices; and
at least one arbiter, wherein each arbiter is operable to assign a graphics processing time-slice to the one or more virtual machines;
wherein each graphics processing unit comprises:
a graphics processing unit instance, wherein the graphics processing unit instance is operable to perform graphics processing for the assigned virtual machine during the assigned graphics processing time-slice; and
a management component operable to facilitate one or more signals between the one or more virtual machines, the arbiter and/or the graphics processing unit; and
wherein the graphics processing unit instance is further operable to suspend the graphics processing time-slice for the assigned virtual machine in response to a suspend trigger generated by the management component in response to a signal from the arbiter.

2. The data processing system of claim 1, further comprising:
a memory; and
wherein the graphics processing unit instance is further operable to:
suspend each process executing on the graphics processing unit relating to the graphics processing for the assigned virtual machine; and
write a current execution state of the graphics processing unit instance relating to the graphics processing for the assigned virtual machine to the memory.

3. The data processing system of claim 1, in which the management component is further operable to:
receive an interrupt signal from the arbiter; and
forward the interrupt signal to the graphics processing unit instance;
wherein the graphics processing unit instance is further operable to, on receipt of the interrupt signal, perform the suspension of the graphics processing time-slice for the assigned virtual machine.

4. The data processing system of claim 1, in which the graphics processing unit instance is further operable to:
signal the arbiter, via the management component, on completion of the suspension of the graphics processing time-slice for the assigned virtual machine; and
wherein the management component, on receipt of the signal, is further operable to:
trigger an unassignment of the graphics processing unit instance from the assigned virtual machine; and
clear a state of the graphics processing unit instance, such that the graphics processing unit instance can be assigned to a further virtual machine of the one or more virtual machines.

5. The data processing system of claim 1, in which the arbiter is further operable to:
signal the management component to switch from the assigned virtual machine to a further virtual machine of the one or more virtual machines prior to the graphics processing unit instance completing the suspension of the graphics processing time-slice for the assigned virtual machine.

6. The data processing system of claim 1, in which the management component is further operable to:
store a state of one or more of the virtual machines; and
initialise, based on the stored state of the assigned virtual machine, the graphics processing unit instance.

7. The data processing system of claim 1, in which the processor is operable to execute a controller virtual machine and wherein the arbiter is at least part of the controller virtual machine.

8. The data processing system of claim 1, in which the arbiter is at least part of the graphics processing unit, preferably wherein the arbiter is at least part of the management component.

9. A method of operating a data processing system according to claim 1;
the method comprising:
assigning, by the arbiter, the graphics processing unit instance to a virtual machine of the one or more virtual machines for a graphics processing time-slice;
performing, by the graphics processing unit instance, graphics processing for the assigned virtual machine during the graphics processing time-slice; and
suspending, by the graphics processor unit instance, the graphics processing time-slice for the assigned virtual machine in response to a suspend trigger generated by the management component in response to a signal from the arbiter.

10. The method of claim 9, in which suspending the graphics processing time-slice further comprises:
suspending, by the graphics processing unit, each process executing on the graphics processing unit instance relating to the graphics processing for the assigned virtual machine;
and
writing, by the graphics processing unit instance, a current execution state of the graphics processing unit instance relating to the graphics processing for the assigned virtual machine to a memory.

11. The method of claim 9, further comprising:
receiving, by the management component, an interrupt signal from the arbiter; and
forwarding, by the management component, the interrupt signal to the graphics processing unit instance;
wherein, on detection of the interrupt signal, the graphics processing unit instance performs the suspension of the graphics processing time-slice for the assigned virtual machine.

12. The method of claim 9, further comprising:
signalling, by the graphics processing unit instance, the completion of the suspension of the graphics processing time-slice for the assigned virtual machine to the management component; and
on receipt of the signal by the management component, the method further comprises:
triggering an unassignment of the graphics processing unit instance from the assigned virtual machine; and
clearing a state of the graphics processing unit instance, such that the graphics processing unit instance can be assigned to a further virtual machine of the one or more virtual machines.

13. The method of claim 9, further comprising:
transmitting, by the arbiter, a signal to the management component to switch from the assigned virtual machine to a further virtual machine of the one or more virtual machines prior to the graphics processing unit instance completing the suspension of the graphics processing time-slice for the assigned virtual machine.

14. The method of claim 9, further comprising:
storing, by the management component, a state of one or more virtual machines;
initialising the graphics processing unit instance based on the stored state of the assigned virtual machine.

15. A graphics processor operable to perform one or more graphics processing time-slices, the graphics processor comprising:
a graphics processing unit instance, wherein the graphics processing unit instance is operable to perform graphics processing for the assigned virtual machine during the assigned graphics processing time-slice; and
a management component operable to facilitate one or more signals between the one or more virtual machines, an arbiter and/or the graphics processing unit; and
wherein the graphics processing unit instance is further operable to suspend the graphics processing time-slice for the assigned virtual machine in response to a suspend trigger generated by the management component in response to a signal from the arbiter, wherein the arbiter is operable to assign a graphics processing time-slice to the one or more virtual machines.
